(19) United States
(12) Patent Application Publication
(10) Pub. No.: US 2003/0135455 A1
(43) Pub. Date: Jul. 17, 2003

(54) System and method to account for alternative telecommunications/internet transactions

(76) Inventors: Rob Britton, San Diego, CA (US); Daniel Joseph Berkich, Santee, CA (US)

Correspondence Address: NEIL K. NYDEGGER, NYDEGGER & ASSOCIATES, 348 Olive Street, San Diego, CA, 92103, US

(21) Appl. No.: 10/044,537

(22) Filed: Jan. 11, 2002

(51) Int. Cl. G06F 17/60

(52) U.S. Cl. 705/39

(57) ABSTRACT

A system and method that accounts for the monetary value of a communication (transaction) selectively conducted between two parties over either a telecommunications network, or on the internet, involves an inter-party transaction agency. Pre-paid or credit accounts for a buyer (first party) are established at the transaction agency. The buyer then uses funds in the pre-paid account to either: 1) purchase electronically downloadable products from websites that have been individually presented by respective sellers, or 2) engage in telephone conversations with second parties. In either case, the transaction agency debits the buyer's account and appropriately credits a seller's account.

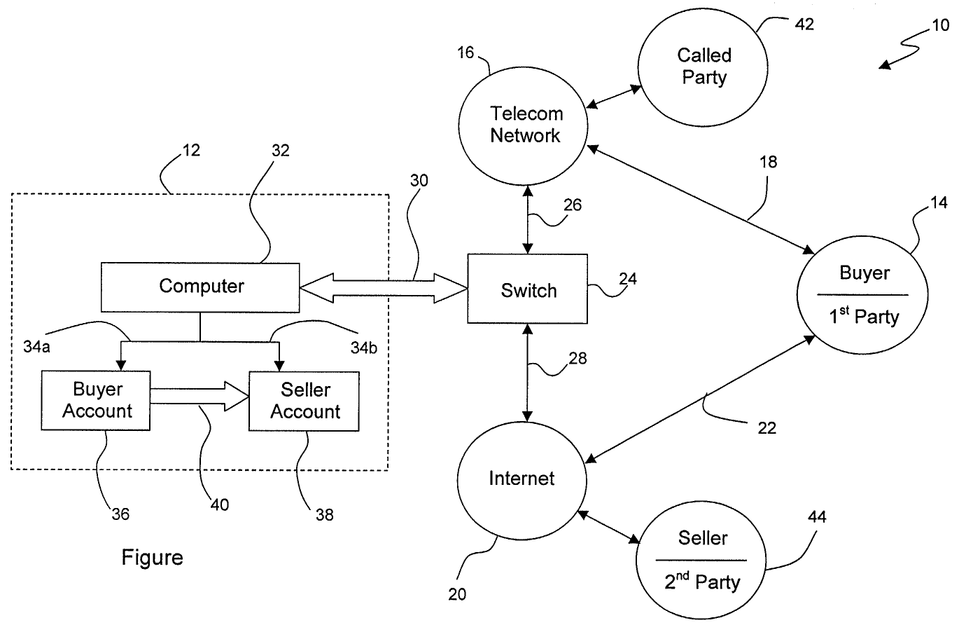

### FIELD OF THE INVENTION

The present invention pertains generally to electronic switching equipment as it is used to establish communications links between parties. More particularly, the present invention pertains to switching equipment that is capable of determining and extracting descriptive information about a particular communication. The present invention is particularly, but not exclusively, useful for systems and methods that can account for the monetary commercial value involved in a communication when the communication link can be selectively switched and conducted on either a telecommunications network or on the internet.

### BACKGROUND OF THE INVENTION

In its simplest form, a commercial financial transaction involves the direct transfer of value between parties to the transaction. Typically, this requires the tender of money from a buyer to a seller in exchange for the transfer of a product from the seller to the buyer. This is most easily accomplished when the buyer and seller are in a face-to-face meeting. As we know, however, present day financial transactions often become quite complex. Indeed, it is not uncommon that a financial transaction will require ancillary agreements and, perhaps, even the involvement of third parties. A consequence of all this has been that the cost involved to complete a transaction may, as a practical matter, be prohibitive. Specifically, this will likely be the case when the quid-pro-quo (consideration) for the transaction has a very low economic value and the transaction is accomplished electronically.

Presently, as is well known, it is possible to quickly and effectively transfer information by electronic means. In particular, electronic transfers are routinely conducted on global computer communications networks (i.e. the internet). As in any other marketplace, the commercial value of these transactions will vary significantly. While some electronically transferable information (i.e. products) may have substantial value (e.g. sound recordings), others do not (e.g. horoscopes). In any case, there is always some value. Heretofore, in the particular case of downloadable products, the relatively low economic value of these products has generally made their sale on the internet cost prohibitive. This situation, however, is now changing with the introduction of systems and methods into e-commerce such as are disclosed in U.S. patent application Ser. No. 09/728,361, which was filed on Dec. 1, 2000 for an invention entitled “A Secured Commercial Transaction.”

In U.S. patent application Ser. No. 09/728,361, referenced above, the underlying premise for facilitating low-value financial transactions in e-commerce is based on the notion that individual buyers should be able to deal directly with individual sellers. On the one hand, this requires the funding of user-friendly, pre-paid accounts by buyers, or the creation of credit accounts for the buyers. On the other hand, this also requires the creation of internet websites by individual sellers. In this scheme, an inter-party transaction agency, which manages accounts for both buyers and sellers, can then pay sellers from the pre-paid accounts of the buyers as transactions between buyers and sellers are made. Although the balance of these prepaid accounts may be minimal (e.g. less than $50), it can happen that the owner of a pre-paid account may desire to use funds in the balance of the account for purposes other than the purchasing of downloadable products from the internet. In which case, it would be desirable to provide the owner of the pre-paid account with an alternative, such as phone services.

In light of the above, it is an object of the present invention to provide a system and method that accounts for the monetary value of a communication between two parties when the communication may alternatively be conducted over a telecommunications network or on the internet. Another object of the present invention is to provide a system and method that accounts for the monetary value of a communication between two parties when the monetary value is established either by one of the parties, or by a third party network provider. Still another object of the present invention is to provide a system and method that accounts for the monetary value of a communication between two parties that is easy to use, is simple to implement, and is comparatively cost effective.

### SUMMARY OF THE PREFERRED EMBODIMENTS

A system for using a transaction agency to account for either telecommunications or internet communications between a buyer (first party) and a seller (second party), involves a switch. Specifically, the switch is used to interconnect a first transceiver that is being used by the buyer (first party), with a second transceiver that is used by the seller (second party). Importantly, the switch has the capability of selectively switching between a first mode, wherein the communication between the parties is conducted on a telecommunications network, and a second mode, wherein their communication is conducted in e-commerce on the internet.

An integral component of the system of the present invention is the inter-party transaction agency. More particularly, by providing the transaction agency with predetermined information that describes a communication between parties, an accounting for the monetary value of the communication can be made. As envisioned for the present invention, this predetermined information can vary according to the type of communication that is involved. In most instances it will at least include: 1) the monetary value of the communication as established by a seller or a provider; 2) the identification of respective buyer and seller (provider) accounts at the transaction agency; and 3) in the case of telecommunications, the time duration of the communication.

In operation, the buyer (first party) will indicate the desired mode (link) that is to be used for conducting the communication. This can be done in any of several ways. For one, the buyer (first party) can manually select the desired communications mode. For another, the transceiver that is being used by the buyer (first party), i.e. telephone or computer, can provide an identifying characteristic to the switch that will automatically indicate the appropriate communications mode. At the same time, the transaction agency will determine whether the buyer's pre-paid account at the transaction agency has sufficient funds to support the transaction. If so, the communication proceeds.

As indicated above, each transaction (communication) will be accounted for at the transaction agency. Using the predetermined information about the particular communication, the transaction agency will debit the monetary value of the communication from an account of the buyer at the transaction agency. The transaction agency will then credit at least a portion of the monetary value of this communication to an account of the seller at the transaction agency. In cases where the transaction involves information that is electronically downloadable from the internet, sellers will preferably have established accounts at the transaction agency where credited funds can be held until payment. Where the transaction involves telecommunications, payments can be made directly from the transaction agency to the appropriate carrier (provider).

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

The FIGURE is a schematic drawing of the system of the present invention.

### DESCRIPTION OF THE PREFERRED EMBODIMENT

Referring to the FIGURE, a system in accordance with the present invention is shown schematically and is generally designated 10. As shown, a transaction agency 12 is interconnected through the system 10 with a buyer (first party) 14. Further, depending on the particular type of transceiver that is used by the buyer 14 (i.e. either telephone or personal computer), the buyer 14 can alternatively be connected to either a telecommunications network 16, via an interconnecting line 18, or with the internet 20 via an interconnecting line 22. In either case, the buyer 14 will be connected with a switch 24. Specifically, these connections will be made via an interconnecting line 26 from the telecommunications network 16 or via an interconnecting line 28 from the internet 20. As intended for the present invention, the interconnecting lines 18, 22, 26 and 28 may be of any type known in the pertinent art, to include wireless links and land lines.

The FIGURE also shows that the transaction agency 12 is connected with the switch 24 via a central connection 30 which, like the interconnecting lines 18, 22, 26 and 28, may be of any type known in the pertinent art. More specifically, the switch 24 is connected with a computer 32 at the transaction agency 12. In turn, the computer 32 is electronically connected (as indicated by line 34a) with a pre-paid buyer's account 36, and with a seller's account 38 (indicated by line 34b). Also, there is an interconnect 40 at the transaction agency 12 between the buyer's account 36 and the seller's account 38. Although the buyer's account 36 will preferably be a pre-paid account, it is to be appreciated that the buyer's account 36 may alternatively be a credit account.

In the operation of the system 10, the buyer 14 determines the mode of communication he/she desires. For instance, to conduct a telephone conversation with a called party 42, the buyer (first party) 14 merely establishes access to the telecommunications network 16. The fact that this access is being established is then passed through the switch 24 to the transaction agency 12. If the buyer's pre-paid account 36 can support the communication, the telephone conversation is allowed to commence. Subsequently, predetermined information, such as the time duration of the communication and the distance of the communication, is passed to the transaction agency 12. This predetermined information is then manipulated by the computer 32 to determine a monetary value for the communication. Once the communication has been completed, or the buyer's account 36 can no longer support the communication, a final monetary value is determined and debited from the buyer's account 36 by the transaction agency 12. A prearranged portion of this monetary value is then transferred to the carrier/provider of the telecommunications network 16.

As envisioned for the present invention, for an alternative to the use of a telecommunications network 16, the buyer 14 may use the system 10 to conduct a transaction with a seller 44 on the internet 20. In this case, the buyer 14 can select a product that can be electronically downloaded from the seller's website on the internet 20. Again, if the buyer's pre-paid account 36 can support the transaction, the buyer 14 is allowed to proceed. Also, in a manner somewhat similar to the telephone conversation discussed above, predetermined information about the transaction is then manipulated by the computer 32 to account for the monetary value of the transaction, as established by the seller 44. This monetary value is then debited from the buyer's account 36 by the transaction agency 12, and a pre-arranged portion of the monetary value is then transferred via the interconnect 40 as a credit to the seller's account 38.

While the particular System and Method to Account for Alternative Telecommunications/Internet Transactions as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for using a transaction agency to selectively account for alternative telecommunication/internet communications between a buyer (first party) and a seller (second party), wherein the communication has a monetary value and the system comprises:
a first transceiver means for use by the buyer to affect the communication;
a second transceiver means for use by the seller to affect the communication;
an electronic means for interconnecting said first transceiver with said second transceiver and for selectively switching between a first mode wherein the communication is conducted on a telecommunications network, and a second mode wherein said communication is conducted in e-commerce on the internet;
a computer means connected with said electronic means for routing predetermined information describing the communication to the transaction agency; and
a means for debiting the monetary value of the communication from an account of the buyer at the transaction agency.

2. A system as recited in claim 1 further comprising a means for crediting at least a portion of the monetary value of the communication to an account of the seller at the transaction agency.

3. A system as recited in claim 1 wherein said first transceiver is a telephone and said electronic means is switched to said first mode.

4. A system as recited in claim 1 wherein said first transceiver is a computer terminal and electronic means is switched to said second mode.

5. A system as recited in claim 1 wherein said predetermined information includes the monetary value of the communication, an identification for the account of the buyer at the transaction agency, and an indication of the selected communication mode being used.

6. A commercial communications system which comprises:
a switching means for selectively connecting a first transceiver in communication with a second transceiver, wherein said first transceiver has an identifying characteristic and the communication has a monetary value;
a routing means, interactive with said switching means and responsive to said identifying characteristic of said first transceiver, and to change between a first communications link wherein said communication is conducted on a telecommunications network and a second communications link wherein said communication is conducted on an internet-type network; and
an evaluating means connected to said switching means for using predetermined information describing the communication to account for the monetary value of the communication.

7. A system as recited in claim 6 wherein the communication is conducted on said first communications link between a first party and a second party, wherein said first communications link is controlled by a third party, and further wherein said evaluating means accounts to said first party and to said third party for the monetary value of the communication.

8. A system as recited in claim 6 wherein said first transceiver is a computer operated by a buyer and said second transceiver is a website operated by a seller, and said communication is conducted on said second communications link.

9. A system as recited in claim 8 wherein said evaluating means accounts to said buyer and to said seller for monetary value of the communication.

10. A system as recited in claim 9 wherein said evaluating means is a transaction agency and said transaction agency debits the monetary value of the communication from an account of the buyer at the transaction agency and credits at least a portion of the monetary value of the communication to an account of the seller at the transaction agency.

11. A system as recited in claim 6 wherein said identifying characteristic indicates said first transceiver is a telephone.

12. A system as recited in claim 6 wherein said identifying characteristic indicates said first transceiver is a computer.

13. A system as recited in claim 6 wherein said predetermined information includes the monetary value of the communication and an indication of the selected communication mode being used.

14. A method for using a transaction agency to account for a communication between a buyer and a seller, wherein the communication has a monetary value and the method comprises the steps of:
providing an electronic means for interconnecting a first transceiver with a second transceiver to affect the communication;
selectively switching between a first mode wherein the communication is conducted on a telecommunications network, and a second mode wherein said communication is conducted in e-commerce on the internet;
routing predetermined information describing the communication to the transaction agency; and
debiting the monetary value of the communication from an account of the buyer at the transaction agency.

15. A method as recited in claim 14 further comprising the step of crediting at least a portion of the monetary value of the communication to an account of the seller at the transaction agency.

16. A method as recited in claim 14 wherein the communication is conducted in said first mode between a first party and a second party, wherein said first mode is controlled by a third party, and further wherein said debiting step accounts to said first party and to said third party for the monetary value of the communication.

17. A method as recited in claim 14 wherein said first transceiver is a computer operated by a buyer and said second transceiver is a website operated by a seller, and said communication is conducted in said second mode.

18. A method as recited in claim 17 wherein said debiting step accounts to said buyer and to said seller for monetary value of the communication.
